(19) United States
(12) Patent Application Publication
(10) Pub. No.: US 2026/0074629 A1
(43) Pub. Date: Mar. 12, 2026

(54) Powering Personal Devices

(71) Applicant: Dylan James O'Brien, Lake Mills, WI (US)

(72) Inventor: Dylan James O'Brien, Lake Mills, WI (US)

(21) Appl. No.: 18/827,927

(22) Filed: Sep. 9, 2024

(51) Int. Cl. H02N 11/00; H01M 10/46; H01M 50/247

(52) U.S. Cl. CPC H02N 11/002; H01M 10/46; H01M 50/247; H01M 2220/30

(57) ABSTRACT

Embodiments of the present disclosure provide a device. The device includes a kinetic energy capture device and a port for an electric connection to an electrically powered device. The kinetic energy capture device converts kinetic energy, provided by a wearer to whom the device is secured, to electric current. The electrically powered device is secured to the wearer. Additionally, the electrically powered device is a different device than the device.

### BACKGROUND

Smart phones, smart glasses, and other mobile devices are machines, and as such, require a source of energy to operate. While these devices may use batteries for power, batteries eventually run low on power. Running low on, and running out of, power, can make it challenging to use mobile devices effectively.

### BRIEF DESCRIPTION OF THE DRAWINGS

FIG. 1 is a diagram of an exemplary system for operating a smart device.

FIG. 2 is a diagram of an exemplary energy device in the exemplary system for operating a smart device.

FIG. 3 is a diagram of an exemplary system for operating a smart device.

### DETAILED DESCRIPTION

As stated previously, mobile devices may have batteries to power them. However, batteries make up a significant portion of the weight of mobile devices. Further, when batteries run low, a mobile device may slow down to conserve power, which may prolong operating time. However, the prolonged time is limited because, without a further charge, the battery will run out of power. Such circumstances can result in a trip to a solitary charging station, rendering a smart, mobile device to a formerly smart, formerly mobile, device.

Any fan of The Matrix franchise knows that human beings are a source of reliable power. In The Matrix, robots collected the power generated by human biochemistry from numerous, immobile human bodies. However, in contrast to the power harvested by robotic overloads from countless, catatonic corpuses in The Matrix movies, human beings can wake up, and when awake, move, thus producing kinetic energy. More specifically, people walk, run, stand up, sit down, and the like. In addition to these examples of voluntary movements, some people fidget, mindlessly or involuntarily. All these activities, and more, produce kinetic energy that may be useful to power mobile devices. Accordingly, examples of the invention described herein can be worn by, or placed nearby, a human (or other live) being, capture kinetic energy generated by that being, generate an electric current using the captured kinetic energy, and use the generated electric current to power a mobile device. This generated electric current may be used to power one or more mobile devices held, carried, or otherwise located nearby a human user. In some embodiments, the generated electric current may charge one or more batteries that can be electrically connected with the mobile device. Alternatively, the generated electric current may be provided to the mobile device via a wired and/or wireless electric connection. In examples of such embodiments, a mobile device may include smart phones, tablets, and implanted devices, such as insulin pumps, pacemakers, and the like.

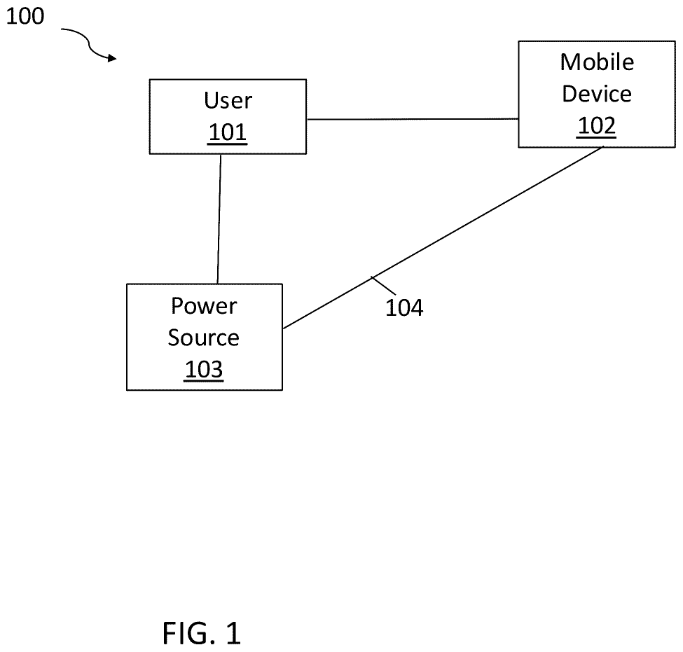

FIG. 1 is a diagram of an exemplary system 100 having a user 101, operating a mobile device 102 with an example mobile device power source (power source) 103. While the mobile device 102 of FIG. 1 appears similar to a smart phone, other mobile devices are possible, such as tablets, laptops, wearable smart devices, and the like.

The power source 103 may include a power store, such as a rechargeable battery, capable of charging by electric current. Additionally, the power source 103 may include an energy generator. In some examples, the power source 103 may be located approximate to an area of a body useful for capturing kinetic energy. For example, the power source 103 may be located on one (or, two) leg(s) of a user. These locations may be useful for capturing kinetic energy when the user is walking, jogging, running, or fidgeting (e.g., by bouncing their leg(s)). In examples of this disclosure, the energy generator generates electric current using energy that the wearer provides. This energy can include the ambient warmth of the wearer's body, the kinetic energy provided by the movement of the wearer, and the like. In some examples, the power source 103 can be secured to a pet, such as a dog, a hamster, and the like. In such examples, the pet may provide kinetic energy by running outdoors, in a hamster wheel, and the like, and thus generate an electric current from that kinetic energy that charges a battery of the power source 103. Additionally, the user 101 may remove the power source 103 from the pet, and connect the power source 103 to the mobile device 102. For example, the power source 103 may include an electroactive polymer, pizoelectric material, a magnetoelastic material, and the like. Additionally, or alternatively, the power source 103 may include a magnet and an electric coil, wherein a motion of the wearer causes the magnet or coil to move in a way that produces electric current in the electric coil.

Further, the power source 103 may charge a power store, using the generated electric current. Accordingly, the power source 103 can provide electric current from the power store to a connected mobile device, e.g., mobile device 102, over a connection 104. In some examples, the power source 103 may include a bypass switch (not shown) that, when activated, bypasses the power store, and provides the electric current generated by the energy capture device, to the mobile device 102 over the connection 104.

The connection 104 may represent a wired and/or wireless connection. For a wired connection, the connection 104 may be a cord, cable, and the like, suitable for providing electric current from the mobile device power source 103 to the mobile device 102. Further, the connection 104 may be incorporated into the clothing of the user 101, which may reduce the possibility of the connection 104 becoming entangled, snagged, and the like. Further, in some examples, the connection 104 may be wireless (e.g., provinding power through induction).

By locating the power source 103 separately from the mobile device, examples of the invention can reduce the weight of a typical mobile device 102. More specifically, the electric current provided by the power source 103 may make it possible to reduce the size of the battery in the mobile device 102 without reducing the amount of power available to the mobile device 102. In some examples, the mobile devices 102 may derive all their power from the power source(s) 103, thus eliminating the weight of a rechargeable battery in the mobile device. Lighter mobile devices may be more comfortable to use and carry. Alternatively, for those used to the weight of the typical mobile device, the mobile device 102 can include the replace the weight and space taken up a battery, with the weight and space taken up by other useful hardware (e.g., more processors, memory, camera components, and the like), in place of the weight of a typical battery.

In this way, the example power source 103 can improve the operation of mobile devices 102 by prolonging their operating life. These example power sources 103 can prolong operating life by charging the mobile device's battery with the electric current generated by the kinetic energy of the user's movements. Alternatively, by providing the generated electric current to the mobile device 102 itself, the user 101 may operate the mobile device 102 while mitigating the loss of power from the mobile device's battery. Thus, instead of having a mobile device 102 die after however many hours the battery's capacity provides alone, examples of the power source 103 can keep replenishing the power store, enabling the mobile device 102 to operate beyond however much time the capacity of the battery alone can provide.

In some examples, the power source 103 can be secured to a pet, such as a dog, a hamster, and the like. In such examples, the pet may provide kinetic energy by running outdoors, in a hamster wheel, and the like, and thus generate an electric current from that kinetic energy that charges a battery of the power source 103. Additionally, the user 101 may remove the power source 103 from the pet, and connect the power source 103 to the mobile device 102. For example, the power source 103 may include For example, The device of claim 1, wherein the kinetic energy capture device comprises a material selected from a group including electroactive polymer, pizoelectric material, and magnetoelastic material.

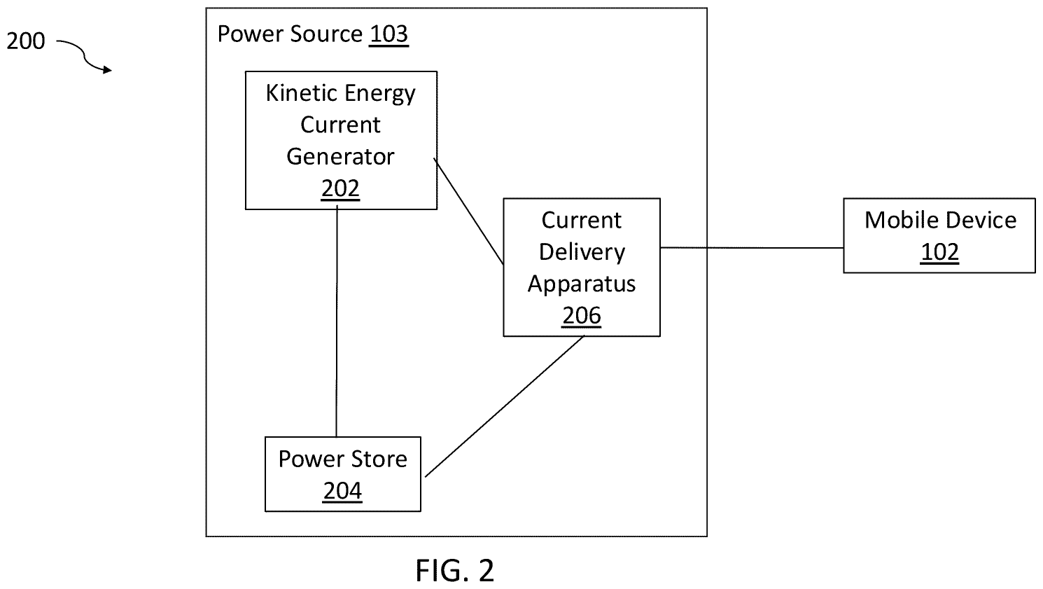

FIG. 2 is a diagram of the example power source 103. The example power source 103 includes a kinetic energy current generator 202, power store 204, charge delivery device 206, and a charging switch. The kinetic energy current generator 202 may include elements that are mechanical, magnetic, or otherwise suitable for capturing kinetic energy from a wearer of the power source 103 and converting the captured energy, or some portion thereof, into electric current. For example, the kinetic energy current generator 202 may include an electroactive polymer, pizoelectric material, a magnetoelastic material, and the like. Additionally, or alternatively, the kinetic energy current generator 202 may include a magnet and an electric coil, wherein a motion of the wearer causes the magnet or coil to move in a way that produces electric current in the electric coil. Additionally, the energy generator 202 may also include elements suitable for delivering the electric current to the power store 204 for storage. Alternatively, or additionally, the energy generator 202 can deliver the electric energy to the mobile device through the connector 106, described in FIG. 1.

The charge delivery device 206 may be an element suitable for providing the energy from the capture device 202 and/or the power store 204. For example, the charge delivery device 206 may be a port (e.g., universal serial bus (USB) port).

The charge switch 208 may be an actuator that controls the flow of current from the power source 103. If the charge switch 208 is in an on position, the power source 103 may provide electric current. Conversely, if the charge switch 208 is in an off position, the power source 103 may not provide electric current.

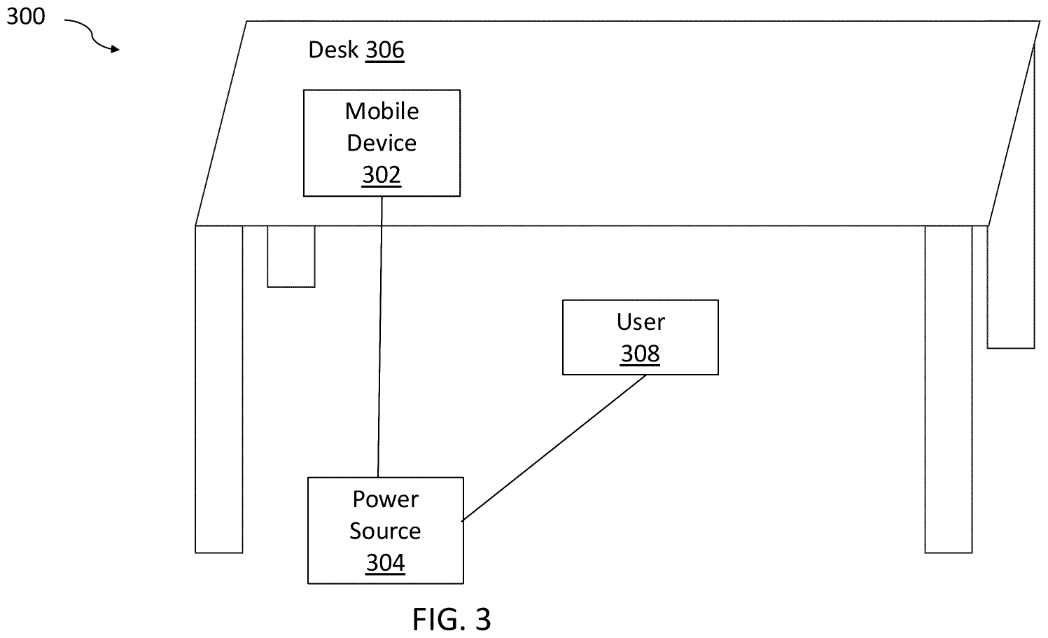

FIG. 3 is a diagram of an exemplary system 300 for operating a mobile device 302 with an example mobile device power source (power source) 304. The exemplary system 300 may represent an office, or other desktop working environment. For example, the mobile device 302 is located on a desk 306, and the power source 304 is located on the floor, under the desk 306. Thus, the user may place their foot on the power source 304, and deliver kinetic energy to the power source by foot tapping, leg shaking, or any other motion bringing the user's body into contact with the power source 304. Additionally, the power source 304 may include a connector 308 that connects to the mobile device 302. Alternatively, the mobile device 302 can be charged through a wireless pad (not shown), that is connected to the power source 304.

1. A device comprising:
a kinetic energy capture device that converts kinetic energy, provided by a wearer to whom the device is secured, to electric current; and
a port for an electric connection to an electrically powered device that is secured to the wearer, wherein the electrically powered device is a different device than the device.

2. The device of claim 1, comprising:
an input electric connection that delivers the electric current to a device battery; and
the device battery, wherein the device battery stores the electric current; and
an output electric connection that delivers stored electric current to the port.

3. The device of claim 1, comprising:
a thermoelectric material that generates additional electric current; and
a thermo-sourced electric connection that delivers the additional electric current to the device battery.

4. The device of claim 1, wherein the electrically powered device is a device battery that powers the electrically powered device.

5. The device of claim 1, wherein the electrically powered device is a medical device.

6. The device of claim 1, wherein the electrically powered device comprises a computer processor.

7. The device of claim 1, wherein the electrically powered device is selected from a group that includes a phone, a camera, and a battery.

8. The device of claim 1, comprising a pedal that receives the kinetic energy, wherein the pedal comprises:
a wearer securing attachment that secures the device to the wearer; and
a surface securing attachment that secures the device to a stable surface.

9. The device of claim 1, wherein the kinetic energy capture device comprises a material selected from a group including electroactive polymer, pizoelectric material, and magnetoelastic material.

10. The device of claim 1, wherein the kinetic energy capture device comprises a magnet and an electric coil, wherein a motion of the wearer causes the magnet or coil to move in a way that produces electric current in the electric coil.
